(19) United States
(12) Patent Application Publication
(10) Pub. No.: US 2024/0369050 A1
(43) Pub. Date: Nov. 7, 2024

(54) AUXILIARY UNIT AND SYSTEM FOR ELECTRICALLY DRIVING A TRUCK-MOUNTED CONCRETE PUMP

(71) Applicant: Schwing GmbH, Herne (DE)

(72) Inventors: Andreas LEHMANN, Moers (DE); Uwe KRISCHAN, Herne (DE); Dirk BRANDENSTEIN, Willich (DE)

(21) Appl. No.: 18/291,215

(22) PCT Filed: Jul. 4, 2022
(86) PCT No.: PCT/EP2022/068446

§ 371 Date: Jan. 22, 2024

(30) Foreign Application Priority Data
Jul. 23, 2021 (DE) 10 2021 119 181.5

(51) Int. Cl. F04B 17/03; E04G 21/04; F04B 15/02; F04B 17/05; F04B 17/06

(52) U.S. Cl. CPC F04B 17/03; F04B 15/02; F04B 17/05; F04B 17/06; E04G 21/0436

(57) ABSTRACT

A system includes a truck-mounted concrete pump and an auxiliary unit. The truck-mounted concrete pump including a hydraulically driven concrete pumping system for conveying concrete, a hydraulic pump drive system, and an internal combustion engine. The internal combustion engine is configured to drive the hydraulic pump drive system, and the hydraulic pump drive system configured to drive the concrete pumping system. The auxiliary unit includes an auxiliary hydraulic pump drive system for hydraulically driving the concrete pump system and an electric motor for driving the auxiliary hydraulic pump drive system.

The invention relates to an auxiliary unit for electrically driving a truck-mounted concrete pump, wherein the truck-mounted concrete pump has a hydraulically driven concrete pump system for conveying concrete and a hydraulic pump drive system and an internal combustion engine, wherein the internal combustion engine is designed to drive the hydraulic pump drive system and the hydraulic pump drive system is designed to drive the concrete pump system. The invention also relates to a truck-mounted concrete pump with a concrete pumping system, wherein the concrete pumping system is electrically driven by an auxiliary power unit and a system with a truck-mounted concrete pump and an auxiliary power unit for electrically driving the truck-mounted concrete pump.

To reduce the emission of undesirable exhaust gases and climate-damaging carbon dioxide, it is desirable to drive truck-mounted concrete pumps, whose concrete pumping system is usually powered by an internal combustion engine, electrically on the construction site.

Patent application DE102018214965A1 discloses a truck-mounted concrete pump with a hydraulic drive pump system for driving the concrete pumping system of the truck-mounted concrete pump, wherein the hydraulic drive pump system is optionally driven by an internal combustion engine or an electric motor. For this purpose, the truck-mounted concrete pump must be equipped with an additional electric motor with great effort. Retrofitting would only be possible with great effort. In addition, the hydraulic drive pump system is designed to be driven by an internal combustion engine with an output of over 200 kilowatt hours, while the electric motor can often only drive the hydraulic pump train with an output of less than 100 kilowatt hours due to the limited electrical power available. This leads to unnecessary power losses when driving the truck-mounted concrete pump with the electric motor.

It is therefore an object of the invention to provide an electric drive for a truck-mounted concrete pump with which an existing truck-mounted concrete pump with an internal combustion engine drive can be easily driven electrically.

A further object of the invention is to minimize power losses in the electrical drive of the truck-mounted concrete pump in order to use the available electrical power as effectively as possible for pump operation.

At least one of these objectives is solved by an auxiliary unit which is suitable for electrically driving a truck-mounted concrete pump with the features of claim 1, a truck-mounted concrete pump which is electrically driven by this auxiliary unit according to the features of claim 8 and a system for electrically driving a truck-mounted concrete pump with the features of claim 11.

Advantageous embodiments and further embodiments of the invention are shown in the dependent claims. It should be pointed out that the features listed individually in the claims can also be combined with one another in any technologically meaningful way and thus demonstrate further embodiments of the invention.

The invention proposes an auxiliary unit suitable for electrically driving a truck-mounted concrete pump, the truck-mounted concrete pump comprising a hydraulically driven concrete pumping system for conveying concrete and a hydraulic pump drive system, a hydraulic oil tank and an internal combustion engine, wherein the internal combustion engine is designed to drive the hydraulic pump drive system and the hydraulic pump drive system is designed to drive the concrete pump system, wherein the auxiliary unit comprises an auxiliary hydraulic pump drive system and an electric motor for driving the auxiliary hydraulic pump drive system, wherein the auxiliary hydraulic pump drive system can be connected to the truck-mounted concrete pump for the hydraulic drive of the concrete pump system.

By using an auxiliary unit with an electric motor to drive an auxiliary hydraulic pump drive system to drive the concrete pumping system of the truck-mounted concrete pump, a truck-mounted concrete pump of conventional design can be very easily driven electrically on a construction site. Only very minor modifications to the truck-mounted concrete pump are required to enable electric operation. The auxiliary hydraulic pump drive system driven by an electric motor can be designed to be driven by the electric motor, which generally has a lower output than the combustion engine, in order to minimize power losses and optimize the auxiliary unit for the electric drive of the truck-mounted concrete pump.

Advantageously, the auxiliary unit has an auxiliary hydraulic oil tank and the hydraulic oil tank of the truck-mounted concrete pump can be connected to the auxiliary hydraulic oil tank of the auxiliary unit via at least one hydraulic backflow line. Because the auxiliary unit has its own hydraulic oil tank, which is connected to the hydraulic oil tank of the truck-mounted concrete pump via a hydraulic backflow line, the auxiliary hydraulic pump drive system always has sufficient hydraulic oil available to drive the concrete pump system of the truck-mounted concrete pump.

According to an advantageous embodiment, the hydraulic oil is conveyed from the hydraulic oil tank of the truck-mounted concrete pump to the auxiliary hydraulic oil tank of the auxiliary unit. This has the advantage that the hydraulic backflow line does not have to be designed as a suction line. Only low flow velocities are permitted for a suction line, so that a suction line would have to have a very large diameter, making it very difficult to connect the hydraulic backflow line from the auxiliary unit to the truck-mounted concrete pump. If the hydraulic oil is conveyed to the auxiliary unit, a pressure line with a high flow rate and a correspondingly smaller diameter can be used.

According to an advantageous embodiment of the invention, the truck-mounted concrete pump, which is electrically driven by the auxiliary unit, has at least one backflow drive motor and at least one hydraulic oil backflow pump, wherein the at least one hydraulic oil backflow pump is designed to convey hydraulic oil from the hydraulic tank of the truck-mounted concrete pump to the auxiliary hydraulic oil tank of the auxiliary unit. With the hydraulic backflow pump, the hydraulic oil can be conveyed from the truck-mounted concrete pump to the auxiliary unit without the combustion engine of the truck-mounted concrete pump having to be in operation.

The backflow drive motor is advantageously designed as an electric motor. This means that the electrical drive power of the auxiliary unit can be used to drive the backflow drive motor.

Alternatively, the backflow drive motor is advantageously designed as a hydraulic motor. This means that the hydraulic drive power of the auxiliary unit can be used to drive the backflow drive motor.

The auxiliary unit preferably has a hydraulic oil cooler and the hydraulic oil is conveyed from the hydraulic oil tank of the truck-mounted concrete pump through the hydraulic backflow line through the hydraulic oil cooler of the auxiliary unit into the auxiliary hydraulic oil tank of the auxiliary unit. This has the advantage that the hydraulic oil, which is conveyed from the hydraulic oil tank of the truck-mounted concrete pump to the auxiliary hydraulic oil tank of the auxiliary unit, can also be easily cooled in this way without having to provide a separate cooling circuit on the truck-mounted concrete pump or the auxiliary unit. Another additional advantage is that the hydraulic oil backflow is divided into two hydraulic backflow lines, the diameter of which can then be smaller than that of one hydraulic backflow line. This makes the individual hydraulic backflow lines easier to handle and connect.

Preferably, the auxiliary unit has a control unit that controls the power or RPM of the backflow drive motor. This ensures that the oil level of the auxiliary hydraulic tank of the auxiliary unit can be kept as constant as possible.

The auxiliary unit preferably has an electrical supply voltage connection for the electrical supply of a control unit of the truck-mounted concrete pump. This has the advantage that the vehicle battery of the truck-mounted concrete pump, which normally provides the electrical power to drive the control unit, is not strained by the current consumption of the control unit while the combustion engine is not in operation and therefore the vehicle battery is not recharged.

The invention further comprises a truck-mounted concrete pump having a hydraulically driven concrete pumping system for pumping concrete and a hydraulic pump drive system and an internal combustion engine, wherein the internal combustion engine is configured to drive the hydraulic pump drive system and the hydraulic pump drive system is configured to drive the concrete pumping system, wherein the concrete pumping system of the truck-mounted concrete pump is connectable to an auxiliary unit for electrically driving the concrete pumping system, wherein the auxiliary unit comprises an auxiliary hydraulic pump drive system for driving the concrete pumping system of the truck-mounted concrete pump and an electric motor for driving the auxiliary hydraulic pump drive system. The fact that the truck-mounted concrete pump can be easily connected to an auxiliary unit, for example with hydraulic lines, in order to drive the concrete pumping system of the truck-mounted concrete pump electrically, means that a truck-mounted concrete pump that was previously usually driven by an internal combustion engine can be used for an environmentally friendly electric drive on a construction site in a very simple way and without complex modifications.

According to an advantageous embodiment of the invention, the truck-mounted concrete pump has a backflow drive motor and at least one backflow hydraulic pump driven by the backflow drive motor, wherein the backflow hydraulic pump is designed to convey hydraulic oil from the hydraulic oil tank of the truck-mounted concrete pump to the auxiliary unit. As the hydraulic oil required to drive the concrete pump system is delivered or pumped from the auxiliary hydraulic pump drive system to the auxiliary unit using a hydraulic oil backflow pump, a relatively thin pressure line can be used for the backflow of the hydraulic oil in contrast to a suction line. Due to the large number and power of the hydraulic consumers to be driven by the auxiliary unit, the hydraulic oil requirement of the hydraulic pumps of the auxiliary unit is very high. If the hydraulic oil required by the auxiliary unit were to be sucked in from the hydraulic oil tank of the truck-mounted concrete pump, as would actually be common in the state of the art, the hydraulic backflow line required for this would have to have a very large diameter due to the limited oil flow rate of a suction line. A hydraulic backflow line with a smaller diameter can also be connected to the truck-mounted concrete pump very easily.

Advantageously, the at least one hydraulic oil backflow pump is designed to feed hydraulic oil from the hydraulic oil tank of the truck-mounted concrete pump to the auxiliary hydraulic oil tank of the auxiliary unit, so that a sufficient amount of hydraulic oil is always available in the auxiliary hydraulic oil tank of the auxiliary unit for the hydraulic pumps of the auxiliary unit.

Preferably, the hydraulic pump drive system of the truck-mounted concrete pump has a plurality of hydraulic pumps and the concrete pump system of the truck-mounted concrete pump has a plurality of hydraulic consumers and the auxiliary hydraulic pump drive system of the auxiliary unit has a plurality of hydraulic pumps, wherein the hydraulic consumers of the truck-mounted concrete pump can be connected to the plurality of hydraulic pumps of the auxiliary unit by means of a plurality of hydraulic supply lines. The hydraulic supply lines can be used to easily connect the hydraulic consumers of the truck-mounted concrete pump to the hydraulic pumps of the auxiliary unit.

The invention is further characterized by a system for electrically driving a truck-mounted concrete pump, wherein the truck-mounted concrete pump comprises a hydraulically driven concrete pumping system for conveying concrete and a hydraulic pump drive system and an internal combustion engine, wherein the internal combustion engine is adapted to drive the hydraulic pump drive system and the hydraulic pump drive system is adapted to drive the concrete pumping system, wherein an auxiliary unit has an auxiliary hydraulic pump drive system for hydraulically driving the concrete pump system of the truck-mounted concrete pump and an electric motor for driving the auxiliary hydraulic pump drive system, wherein the auxiliary hydraulic pump drive system of the auxiliary unit can be connected to the concrete pump system of the truck-mounted concrete pump by means of hydraulic supply lines.

Advantageously, the hydraulic pump drive system of the truck-mounted concrete pump according to the invention comprises a plurality of hydraulic pumps and the concrete pumping system of the truck-mounted concrete pump comprises a plurality of hydraulic consumers and the auxiliary hydraulic pump drive system of the auxiliary unit comprises a plurality of hydraulic pumps and the hydraulic consumers of the concrete pumping system are connectable to the plurality of hydraulic pumps of the auxiliary unit by a plurality of hydraulic supply lines.

According to an advantageous embodiment, the truck-mounted concrete pump of the system for electrically driving a truck-mounted concrete pump has a hydraulic oil tank and the auxiliary unit has an auxiliary hydraulic oil tank, wherein the hydraulic oil tank of the truck-mounted concrete pump and the auxiliary hydraulic oil tank can be connected to at least one hydraulic backflow line. As a result of this arrangement, it is not necessary to provide a separate hydraulic backflow line for each of the hydraulic pumps of the auxiliary unit, which considerably reduces the number of hydraulic lines for connecting the truck-mounted concrete pump to the auxiliary unit, making it much easier to establish the connection.

According to a preferred embodiment, the truck-mounted concrete pump of the system according to the invention has at least one hydraulic oil backflow pump driven by a backflow drive motor and connected to the hydraulic oil tank of the truck-mounted concrete pump, which is designed to convey hydraulic oil from the hydraulic oil tank of the truck-mounted concrete pump to the auxiliary hydraulic oil tank of the auxiliary unit through the at least one hydraulic backflow line.

According to a further preferred embodiment, the truck-mounted concrete pump of the system according to the invention has a second hydraulic oil backflow pump driven by the backflow drive motor and the auxiliary unit has a hydraulic oil cooler and a second hydraulic backflow line connected to the hydraulic oil cooler, wherein the second hydraulic oil backflow pump is designed to convey hydraulic oil from the hydraulic oil tank of the truck-mounted concrete pump through the hydraulic oil cooler into the hydraulic oil tank of the auxiliary unit.

Further features, details and advantages of the invention will become apparent from the following description and from the drawings, which show embodiments of the invention. Corresponding objects or elements are provided with the same reference signs in all figures. It shows:

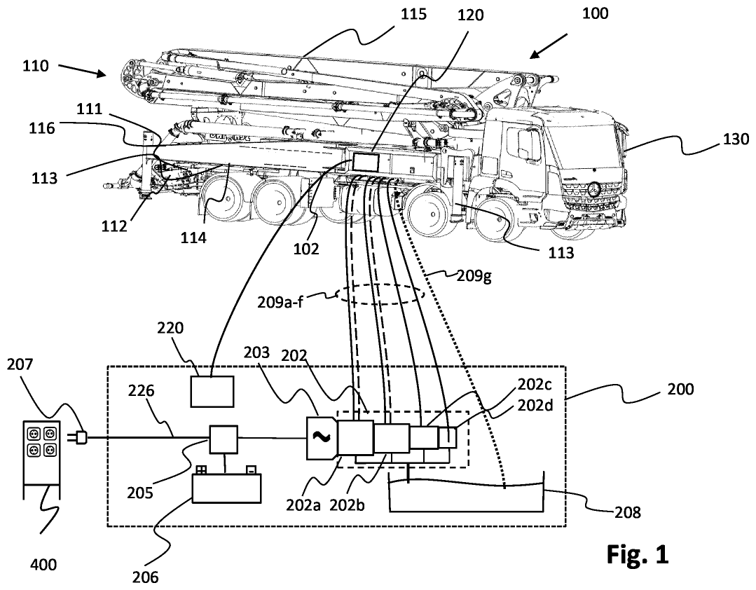

FIG. 1 System according to the invention for electrically driving a truck-mounted concrete pump with an auxiliary unit

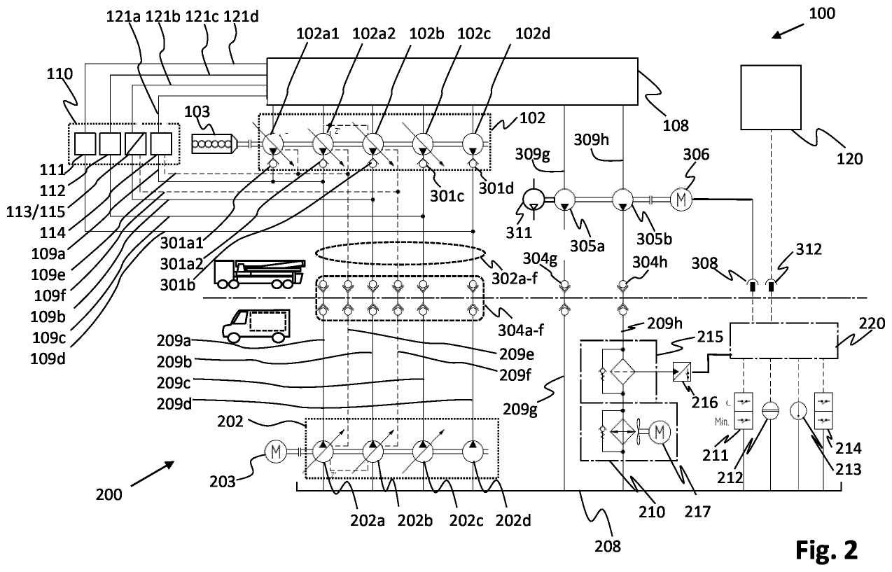

FIG. 2 Hydraulic diagram of the system according to the invention

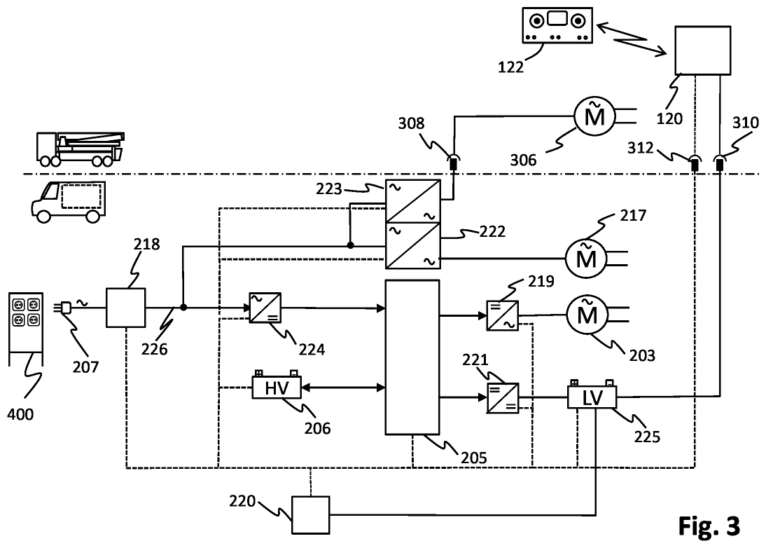

FIG. 3 Electrical circuit diagram of the system according to the invention

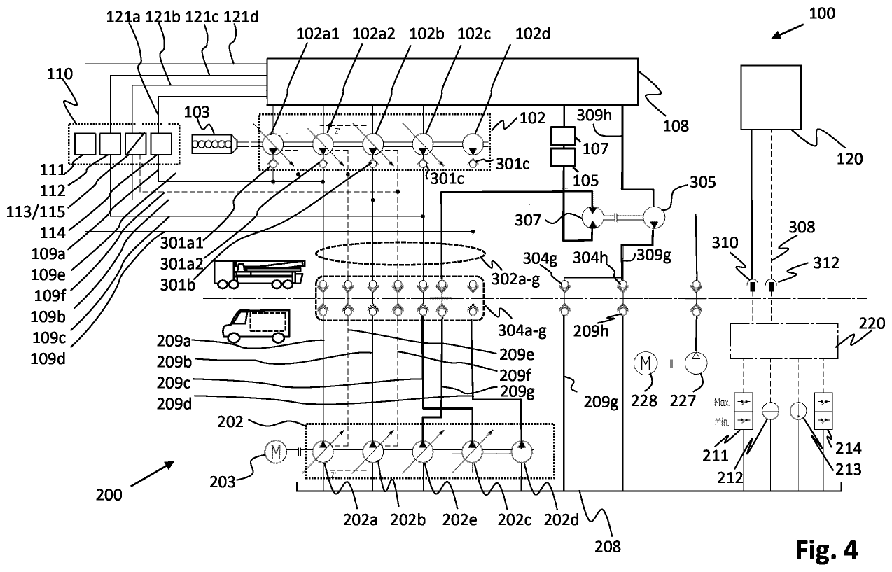

FIG. 4 Variant of a hydraulic diagram of the system according to the invention

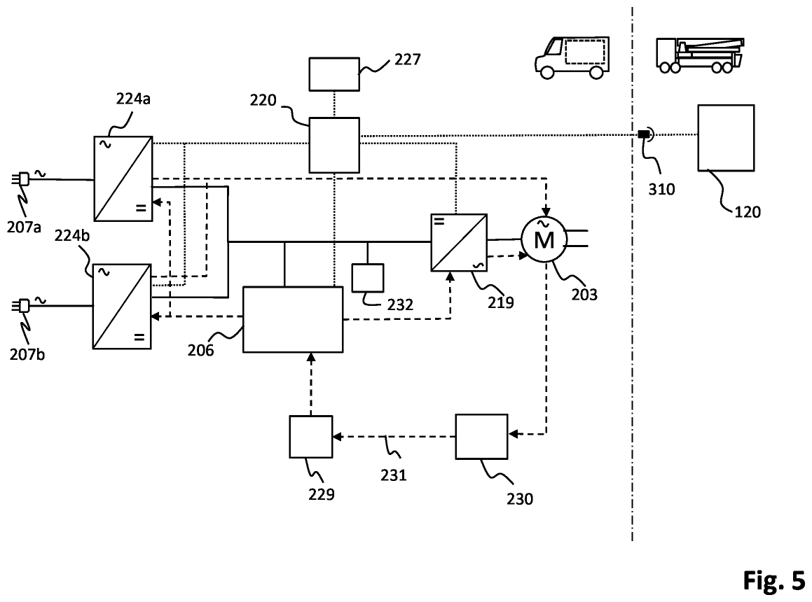

FIG. 5 Variant of an electrical circuit diagram of the system according to the invention

FIG. 1 shows a truck-mounted concrete pump 100, an auxiliary unit 200 and a system for electrically driving a truck-mounted concrete pump 100 with an auxiliary unit 200 according to the invention.

In FIGS. 1 and 2, all elements that are usually present in a conventional truck-mounted concrete pump 100 are marked with the reference symbol 1XX. All elements that are assigned to the auxiliary unit 200 are marked with the reference sign 2XX.

The truck-mounted concrete pump 100 comprises a hydraulically driven concrete pumping system 110 for conveying concrete and a hydraulic pump drive system 102 and an internal combustion engine 103 (FIG. 2), wherein the internal combustion engine 103 is designed to drive the hydraulic pump drive system 102 and the hydraulic pump drive system 102 is designed to drive the concrete pumping system 110.

The truck-mounted concrete pump 100 shown here as an example has a concrete pumping system 110, which is mounted on a truck chassis 130 with a driver's cab. The concrete pumping system 110 comprises various hydraulic consumers 111, 112, 113, 114, 115, for example an agitator 111 for mixing the fresh concrete in the feed hopper 116, a two-cylinder piston pump 114, for example consisting of conveying cylinders which are driven by differential hydraulic cylinders and a concrete changeover valve 112. Instead of a two-cylinder piston pump 114, another pumping technology could also be used, for example a rotor hose pump. Other hydraulic consumers of the concrete pumping system 110 are, for example, a support 113 and a concrete placing boom 115. The truck-mounted concrete pump 100 could also be equipped with a hydraulically driven mixing drum (truck mixer concrete pump) or, for example, be designed as a simple concrete pump mounted on a truck chassis without a boom and support.

The combustion engine 103 (FIG. 2) of the truck chassis 130 drives the wheels of the truck while driving. As soon as the truck-mounted concrete pump 100 has reached the work site, the combustion engine 103 continues to run according to the prior art and is used to drive the concrete pumping system 110. For the drive by the combustion engine 103, the hydraulic pump drive system 102 of the truck-mounted concrete pump 100 has a plurality of hydraulic pumps 102a1, 102a2, 102b, 102c, 102d (FIG. 2), which drive the hydraulic consumers 111, 112, 113, 114, 115 of the concrete pump system 110 via the hydraulic supply lines 109a-d. The hydraulic control lines 109e and 109f are used to control the adjustable hydraulic pumps 102a and 102b by the hydraulic consumers 113/115 and 114. The hydraulic pumps 102a1, 102a2, 102b, 102c, 102d (FIG. 2) suck the hydraulic oil for driving the concrete pumping system 110 from a hydraulic oil tank 108 (FIG. 2) of the truck-mounted concrete pump 100.

The auxiliary unit 200 of the apparatus according to the invention has an auxiliary hydraulic pump drive system 202 for hydraulically driving the concrete pumping system 110 of the truck-mounted concrete pump 100 and an electric motor 203 for driving the auxiliary hydraulic pump drive system 202. The electric motor 203 is connected to a power connection, for example a construction site power distributor 400, via a power distribution unit 205, a power line 226 and a plug 207. The auxiliary unit 200 can, for example, additionally comprise an optional accumulator 206 which, depending on the capacity of the accumulator 206, can drive the electric motor 203 alone for a certain period of time or provide additional power in addition to the construction site power in order to absorb power peaks of the concrete pumping system 110. The accumulator 206 can be charged by the construction site power distributor 400 via the electrical power distribution unit 205, for example during pumping breaks or phases of low power demand of the concrete pumping system 110. The capacity of the accumulator 206 could also be so large that the construction site power connection 400 can be completely dispensed with. Alternatively or in addition to the accumulator 206, a fuel cell could be used. The accumulator 206 could, for example, also be arranged outside the auxiliary power unit 200. The construction site power distributor 400 could also be supplemented by a fuel cell or an electric accumulator, for example to supply the entire construction site. In addition or as an alternative to the accumulator 206, the auxiliary unit 200 could have a supercapacitor for covering short-term power peaks.

The auxiliary hydraulic pump drive system 202 of the auxiliary unit 200 also has a plurality of hydraulic pumps 202a, 202b, 202c, 202d. The hydraulic consumers 111, 112, 113, 114, 115 of the truck-mounted concrete pump 100 are connected by a plurality of hydraulic supply lines 209a-d to the plurality of hydraulic pumps 202a, 202b, 202c, 202d of the auxiliary power unit 200. Thus, the auxiliary hydraulic pump drive system 202 of the auxiliary power unit 200 can electrically drive the hydraulic consumers 111, 112, 113, 114, 115 of the concrete pumping system 110 of the truck-mounted concrete pump 100 and the internal combustion engine 103 and the hydraulic pump drive system 102 of the truck-mounted concrete pump 100 are not required for driving the concrete pumping system 110. The hydraulic control lines 209e, 209f from the hydraulic consumers 113, 114, 115 to the hydraulic pumps 202a, 202b are used to transmit hydraulic control signals. If electronically controlled hydraulic pumps 202a, 202b are used, these control signals could alternatively also be transmitted electrically.

The auxiliary unit 200 has an auxiliary hydraulic oil tank 208, and the hydraulic oil tank 108 of the truck-mounted concrete pump and the auxiliary hydraulic oil tank 208 of the auxiliary unit 200 are connected to one another by at least one hydraulic backflow line 209g, shown as a dotted line in FIG. 1, in order to convey hydraulic oil from the hydraulic oil tank 108 of the truck-mounted concrete pump 100 to the auxiliary hydraulic oil tank 208 of the auxiliary unit 200.

FIG. 2 shows a detailed hydraulic diagram of the system according to the invention. All elements that must be additionally provided or retrofitted for the electric drive by the auxiliary unit 200 in a conventionally, i. e. combustion engine-driven truck-mounted concrete pump 100, are provided here with the reference signs 3XX, unless they are already present on the truck-mounted concrete pump 100 for other reasons.

For a better understanding of the invention, the operation of the truck-mounted concrete pump 100 with the internal combustion engine 103 is first described below.

The hydraulic pump drive system 102 of the truck-mounted concrete pump 100 shown in FIG. 2, which is driven by the internal combustion engine 103, has, for example, two hydraulic pumps 102a1 and 102a2, which in internal combustion engine mode jointly drive the two-cylinder piston pump 114 of the concrete pumping system 110 via the hydraulic supply line 109a. Due to the high power of the internal combustion engine 103, the truck-mounted concrete pump 100 in this example has two hydraulic pumps 102a arranged in series, i.e. mechanically operated in series, in order to achieve the highest possible pumping capacity and thus fully utilize the power of the internal combustion engine 103. Furthermore, a hydraulic control line 109e leads from the two-cylinder piston pump 114 to the hydraulic pumps 102a1 and 102a2 for controlling the output of the adjustable hydraulic pumps 102a1 and 102a2.

The hydraulic pump 102b drives the concrete placing boom 115 and the support 113 via the hydraulic supply line 109b. A hydraulic control line 109f also leads back to the hydraulic pump 102b, for example to adjust the hydraulic pressure of the hydraulic pump 102b to the respectively required supply pressure of the concrete placing boom 115.

The hydraulic pump 102c, which is designed as a regulating pump, drives the concrete switching valve 112 via an intermediate hydraulic pressure accumulator (not shown) via the hydraulic supply line 109c. The hydraulic pump 102d, which is designed as a constant-flow pump, drives the agitator 111 in the feed hopper 116 of the truck-mounted concrete pump 100 via the hydraulic supply line 109d.

All hydraulic pumps 102a-d of the hydraulic pump drive system 102 draw the hydraulic oil directly from the hydraulic oil tank 108 of the truck-mounted concrete pump 100. The hydraulic oil flows from the hydraulic consumers 111, 112, 113, 114, 115 via the hydraulic backflow lines 121a-d back into the hydraulic oil tank 108 of the truck-mounted concrete pump 100.

Depending on the equipment of the truck-mounted concrete pump 100, it could have additional hydraulic pumps. For example, if the truck-mounted concrete pump 100 has no concrete placing boom 115 and no support 113, the corresponding hydraulic pump 102b can be omitted. In the case of a truck mixer concrete pump, for example, an additional hydraulic pump could be provided to drive a mixing drum. The assignment of the hydraulic pumps 102a-d is also variable, which means in particular that the constant-flow pumps 102c and 102d, for example, can drive further hydraulic consumers or can be combined into one hydraulic pump, for example.

In the following, the electric drive of the truck-mounted concrete pump 100 by means of the auxiliary unit 200 according to the invention is described.

The auxiliary hydraulic pump drive system 202 of the auxiliary unit 200, which is driven by an electric motor 203, has a hydraulic pump 202a, which drives the two-cylinder piston pump 114 of the truck-mounted concrete pump 100 via the hydraulic supply lines 209a and 109a. For this purpose, the hydraulic supply line 209a is connected to the supply line 109a to the two-cylinder piston pump 114, for example with a hydraulic quick coupling 304a and a T-connection piece. A hydraulic control line 209e leads from the two-cylinder piston pump 114 to the hydraulic pump 202a. Because the electric motor 203 driving the auxiliary hydraulic pump drive system 202 generally has a smaller drive power (for example <100 KW) than the internal combustion engine 103 due to the limited electrical power available, the drive power of the hydraulic pump 202a for driving the two-cylinder piston pump 114 can be dimensioned correspondingly smaller than the joint drive power of the hydraulic pumps 102a1 and 102a2 in order to utilize the available electrical drive power as effectively as possible. This also results in a cost saving for the auxiliary unit 200.

The hydraulic pumps 202b, 202c and 202d accordingly drive the hydraulic consumers 111, 112, 113, 115 via the hydraulic supply lines 209b, 209c and 209d, with which the connection between the auxiliary unit 200 and the truck-mounted concrete pump 100 is established. In particular, the hydraulic pump 202c of the auxiliary unit 200, which drives the concrete switching valve 112, can be dimensioned smaller than the hydraulic pump 102c of the truck-mounted concrete pump 100, for example, because the two-cylinder piston pump 114 operates correspondingly slower due to the low electric motor drive power of the auxiliary unit 200 and more time remains for the charging process of the hydraulic pressure accumulator for the switching valve 112. This can also increase the efficiency of the auxiliary unit 200 and save costs.

The hydraulic pump drive system 102 of the truck-mounted concrete pump 100 driven by the internal combustion engine 103 is usually designed for a variable speed of the internal combustion engine 103, because the engine speed of the internal combustion engine 103 must be increased, if the two-cylinder piston pump 114 demands higher power, for example.

In contrast, the auxiliary hydraulic pump drive system 202 of the auxiliary unit 200 can advantageously be designed for a constant drive speed of the electric motor 203. In particular, this is the case if it is a synchronous electric motor 103, which usually operates at a constant speed and can deliver both high and low power at this constant speed without incurring losses. Knowledge of the constant speed of the electric motor 203 can be used to further optimize the auxiliary hydraulic pump drive system 202.

The electric motor 203 can drive the hydraulic pumps 202a, 202b, 202c, 202d with a maximum available torque. This available maximum torque can be fully utilized by the hydraulic pump 202a driving the two-cylinder piston pump 114, minus the torque constantly required by the hydraulic pumps 202c and 202d, to drive the concrete pump 114. If the concrete placing boom 115 is moved during pumping operation and the hydraulic pump 202b absorbs torque from the electric motor 103 for this purpose, the maximum power consumption of the hydraulic pump 202a can, for example, be limited accordingly by an electronic or hydraulic control system for the period of the placing boom movement in order to prevent an overload of the electric motor 103 or an undersupply of the hydraulic drive of the truck-mounted concrete pump 100.

The hydraulic pumps 202a-d of the auxiliary hydraulic pump drive system 202 draw the hydraulic oil required to drive the concrete pumping system 110 from the auxiliary hydraulic oil tank 208 of the auxiliary unit 200.

In order to prevent hydraulic oil from being pumped into the hydraulic pumps 102a-d, which are not active in this operating mode, by the hydraulic pumps 202a-d of the auxiliary unit 200 during the electric drive of the truck-mounted concrete pump 100, a check valve 301a-d is arranged at the outlet of each hydraulic pump 102a-d, for example. In addition to the hydraulic quick couplings 304a-f, the hydraulic system of the truck-mounted concrete pump 100 for the electric drive has T-hydraulic connectors for coupling the hydraulic lines 302a-f.

In this exemplary embodiment, the hydraulic pumps 202a-d of the auxiliary unit 200 are relatively clearly assigned to the hydraulic pumps 102a-d of the truck-mounted concrete pump 100. This does not always have to be the case. For example, the structure of the auxiliary hydraulic pump drive system 202 shown in FIG. 2 could also be used to drive a truck-mounted concrete pump 100 that has no concrete placing boom 115 and/or no support 113. The corresponding hydraulic pump 202b would then simply not be connected to the concrete pumping system 110. Similarly, individual hydraulic pumps of the auxiliary hydraulic pump drive system 202 could be combined into one hydraulic pump, for example with a larger output. This could save one of the hydraulic supply lines 209a-d. The hydraulic drive flow of this combined hydraulic pump can then be split again on the truck-mounted concrete pump 100. It would also be conceivable to use the structure of the auxiliary hydraulic pump drive system 202 shown in FIG. 2 to electrically drive a truck mixer concrete pump, for example, by assigning one of the hydraulic pumps 202a-d to the mixer drum drive.

In FIG. 1, all connections on the truck-mounted concrete pump 100 for connection to the auxiliary unit 200 are arranged on the right-hand side of the truck-mounted concrete pump 100. These connections can, for example, also be arranged on the left or on both sides of the truck-mounted concrete pump 100 in order to place and connect the auxiliary unit 200 on both sides of the truck-mounted concrete pump 100 as desired. It is also conceivable to arrange the connections at other positions on the truck-mounted concrete pump 100.

FIG. 2 further shows that the truck-mounted concrete pump 100 for the electric drive by the auxiliary unit 200 has, for example, a hydraulic oil backflow pump 305a driven by a backflow drive motor 306 and connected to the hydraulic oil tank 108 of the truck-mounted concrete pump 100, which is connected to the hydraulic tank 108 of the truck-mounted concrete pump 100 by a suction line 309g. In this embodiment example, the backflow drive motor 306 is designed as an electric motor. The hydraulic oil backflow pump 305a conveys hydraulic oil from the hydraulic oil tank 108 of the truck-mounted concrete pump 100 to the auxiliary hydraulic oil tank 208 of the auxiliary unit 200 through the at least one hydraulic backflow line 209g, 209h.

The backflow electric drive motor 306 can, for example, additionally drive a second hydraulic oil backflow pump 305b, which draws hydraulic oil, for example, from the hydraulic tank 108 via a further suction line 309h and delivers it from the hydraulic oil tank 108 of the truck-mounted concrete pump 100 via a hydraulic oil filter 215 and a hydraulic oil cooler 210 to the auxiliary hydraulic oil tank 208 of the auxiliary unit 200. The delivery rate of the hydraulic oil backflow pump 305b should, for example, be matched to the rated output of the hydraulic oil filter 215 so that the amount of oil delivered through the hydraulic oil filter 215 is not too large and the hydraulic oil filter 215 is not destroyed as a result. The delivery rate of the hydraulic oil backflow pump 305b is then, for example, approximately half as large as the delivery rate of the hydraulic oil backflow pump 305a.

Alternatively, if only one hydraulic backflow line 209g is used, the hydraulic oil flow on the auxiliary unit 200 could be split into two flows, with one flow going directly to the auxiliary hydraulic oil tank 208 and another hydraulic flow going to the auxiliary hydraulic oil tank 208 via the hydraulic oil cooler 210 and hydraulic oil filter 215. Alternatively, the hydraulic flow can be split even further to the hydraulic oil cooler 210 and the hydraulic oil filter 215.

Depending on the configuration, the concrete pump system 110 of the truck-mounted concrete pump 100 requires compressed air, for example to shut off the concrete delivery line. During operation with the combustion engine 103, this compressed air is generated by a compressor driven by the combustion engine 103, among other things also for supplying the brake system of the chassis 130. Because the internal combustion engine 103 is not available for the generation of compressed air during the electric drive by the auxiliary unit 200, the backflow electric motor 306 can, for example, also drive an air compressor 311, as shown in FIG. 2. Alternatively, the compressor 311 could be driven by a separate electric motor arranged on the truck-mounted concrete pump 100. Alternatively, the compressor 311 could also be arranged on the auxiliary unit 200 and additionally driven by the electric motor 203 or a separate electric motor. When the compressor 311 is arranged on the auxiliary unit 200, it is necessary to provide a compressed air hose between the auxiliary unit 200 and the truck-mounted concrete pump 100.

In the exemplary embodiment shown in FIG. 2, the fan of the hydraulic oil cooler 210 is driven by an electric motor 217. Furthermore, the auxiliary unit 200 has a continuously operating oil level sensor 212. Based on the output value of the oil level sensor 212, the control unit 220 regulates the power or the speed of the backflow electric motor 306 in order to keep the hydraulic oil level of the auxiliary hydraulic oil tank 208, and thus indirectly also the hydraulic oil level of the hydraulic oil tank 108, as constant as possible. Alternatively or additionally, the hydraulic oil tank 108 of the truck-mounted concrete pump 100 could have a corresponding level sensor for regulating the back flow.

The auxiliary unit 200 also has, for example, a discrete fill level sensor 211 which responds when a minimum or maximum fill level of the auxiliary hydraulic oil tank 208 is reached and thus triggers an emergency stop, for example, when one of these fill levels is reached.

In addition, the auxiliary unit 200 has, for example, a temperature sensor 213 that detects the temperature of the hydraulic oil in the auxiliary hydraulic oil tank 208. A further min/max temperature sensor 214 is used to control the switch-on state of the electric motor 217 of the hydraulic oil cooler 210 in order to cool the hydraulic oil when a maximum temperature is reached.

In addition, the auxiliary unit 200 can have an oil filter sensor 216, which detects the contamination status of the hydraulic oil filter 215 based on the pressure difference in the hydraulic oil filter 215 and thus triggers an adequate reaction of the control unit 220.

The control unit 220 of the auxiliary unit 200 is connected to the control unit 120 of the truck-mounted concrete pump 100 via the connector 312.

FIG. 3 shows an example of a possible electrical circuit of the auxiliary unit 200 according to the invention, the truck-mounted concrete pump 100 and the system for the electrical drive of a truck-mounted concrete pump 100.

The circuit of the auxiliary unit 200 has a power connection 207, which is connected, for example, to a construction site power distributor 400 and optionally an accumulator 206, for example a high-voltage accumulator (200V-800V). The power connection 207 and the accumulator 206 each individually or alone provide the electrical power, in particular for operating the electric motor 203, which drives the auxiliary hydraulic pump drive system 202 of the auxiliary unit 200.

An electrical power distribution unit 205 distributes the electrical power provided by the power connection 207 and/or the accumulator 206, in particular to the electric motor 203 and the high-voltage accumulator 206. For example, the power distribution unit 205 can, on the one hand, pass the electrical power from the power connection 207 directly to the drive of the electric motor 203. In the event, that the electric motor 203 requires little or no electrical power, for example during pumping pauses, the power distribution unit 205 can also divert electrical power from the power connection 207 to the high-voltage accumulator 206 for charging the latter.

The power distribution unit 205 can, for example, be based entirely on direct current technology. This means, for example, that a converter 224 from AC voltage to DC voltage is arranged between the power connection 207, which usually provides AC voltage, and the power distribution unit 205. The accumulator 206, which usually provides a DC voltage, can be connected directly to the power distribution unit 205.

The backflow electric motor 306 arranged on the truck-mounted concrete pump 100 to drive the hydraulic backflow pumps 305a and 305b is, for example, an AC motor 306 and is operated via an AC voltage converter 223. Similarly, the electric motor 217 for driving the hydraulic oil cooler 210 can be operated via an AC voltage converter 222.

Furthermore, the auxiliary unit 200 has, for example, a low voltage accumulator 225, for example in 24 or 48 volt technology, for the control and regulation tasks. The accumulator 225 can, for example, be supplied with electrical energy by the power distribution unit 205 via the DC/DC converter 221. The accumulator 225 is used in particular to supply the control unit 220 of the auxiliary unit 200 and to electrically supply the control unit 120 of the truck-mounted concrete pump 100 via the supply voltage connection 310. The fact that the control unit 120 of the truck-mounted concrete pump 100 is supplied with electrical voltage from the accumulator 225 during electrical operation of the truck-mounted concrete pump 100 with the auxiliary unit 200 ensures that the vehicle battery of the truck-mounted concrete pump 100 is not overloaded or discharged. The accumulator 225 also prevents the control unit of the auxiliary unit 200 from being de-energized if the construction site power supply 400 is interrupted and the accumulator 206 is empty or not available.

The control unit 220 is connected to a current/power sensor 218, which detects the electrical power drawn from the power connection 207 at the power line 226. This allows, for example, the construction site power distributor 400 to be protected against overload and, for example, the electrical power drawn from the construction site power connection 400 can be measured, for example in order to bill the costs for the electrical power drawn on this basis.

The control unit 220 can also be connected to the accumulators 206 and 225 as well as the converters 219, 221, 222, 223, 224 and the power distribution unit 205 for various control and regulation tasks via other control lines, for example a CAN bus system. Furthermore, the control unit 220 is connected to the control unit 120 via a control line using the connector plug 312.

The electrical control of the auxiliary unit 200 was illustrated in the embodiment example using an AC electric motor 103 and an AC construction site power connection. Both the electric motor 103 and the construction site power connection could be based on direct current technology. The electrical control of the auxiliary unit 200 then has a correspondingly different structure.

The operator of the truck-mounted concrete pump 100 can control and operate the concrete pumping system 110 during electrical operation with the auxiliary unit 200 as usual via the control unit 120, for example also with a remote control 122. If, for example, the concrete placing boom 115 is moved via the remote control 122, a higher output is automatically called up by the hydraulic pump 202b of the auxiliary unit 200 and this is also made available. Accordingly, an increase in the delivery rate of the two-cylinder piston pump 114 requested by the operator via the remote control 122 results in the delivery volume of the hydraulic pump 202a being automatically increased.

The two-cylinder piston pump 114 shown in this embodiment example operates with an open hydraulic circuit, which can be recognized in particular by the fact that the hydraulic pumps 102a1, 102a2 and 202a only deliver the hydraulic oil in one direction. However, a two-cylinder piston pump 114 can, for example, also be operated in a closed hydraulic circuit with a reversing pump, which delivers alternately in both directions, and a feed pump. In order to drive a corresponding two-cylinder piston pump 114, the auxiliary unit 200 can, for example, have a corresponding reversing pump and a feed pump as an alternative to the hydraulic pump 202a.

The auxiliary unit 200 can also be designed to drive the concrete pump system 110 of the truck-mounted concrete pump 100 in parallel with the combustion engine drive of the truck-mounted concrete pump 100. This means, for example, that the auxiliary unit 200 drives the concrete pumping system 110 alone when the power requirement of the concrete pumping system 110 is low, for example when supporting the truck-mounted concrete pump 100 and when unfolding the concrete placing boom 115. As soon as the two-cylinder piston pump 114 is put into operation or a high delivery rate of the two-cylinder piston pump 114 is required, the combustion engine 103 can be put into operation in addition to the auxiliary unit 200.

FIG. 4 shows a variant of a hydraulic diagram of a system according to the invention, in which only a hydraulic backflow pump 305 returns the hydraulic oil from the hydraulic oil tank 108 of the truck-mounted concrete pump 100 to the hydraulic oil tank 208 of the auxiliary unit 200. The hydraulic backflow pump 305 is driven by a backflow drive motor 307, which in this embodiment example is a hydraulic motor 307. In this exemplary embodiment, the hydraulic pump train 202 of the auxiliary unit contains a further hydraulic pump 202e, which is arranged between the hydraulic pumps 202b and 202c. The hydraulic pump 202e, which is thus also driven by the electric motor 203, is connected via a further hydraulic line 209g to the backflow hydraulic motor 307 for its drive, so that the hydraulic backflow pump 305 is ultimately driven by the hydraulic pump 202e or the electric motor 203.

For cooling the hydraulic oil, the drive oil of the hydraulic motor 307 is fed into the hydraulic oil tank 108 via the hydraulic oil filter 105 and the hydraulic oil cooler 107 of the truck-mounted concrete pump 100 in this embodiment example. Although this means that only a smaller quantity of oil is cooled than when driven by the internal combustion engine 103, the required cooling capacity is reduced accordingly due to the lower drive power of the auxiliary unit 200. During operation with the internal combustion engine 103, an additional hydraulic pump of the hydraulic pump line 102, not shown, feeds the hydraulic oil from the tank 108 via the oil filter 105 and the hydraulic oil cooler 107 back into the tank 108. This hydraulic pump, not shown, is separated from the drive of the hydraulic motor 307 by a check valve, not shown, for operation by the auxiliary unit 200. The auxiliary hydraulic oil cooler 210 and hydraulic oil filter 215 of the auxiliary unit 200 required in the embodiment example according to FIG. 2 are therefore not necessary. The control unit 220 of the auxiliary unit 200 constantly determines at least the hydraulic oil level of the auxiliary hydraulic oil tank 208 and, in this example embodiment, controls the power of the hydraulic motor 307 via the power adjustment of the hydraulic pump 202e, which supplies the hydraulic motor 307 with hydraulic oil. Alternatively, a controllable hydraulic pump 307 that can be controlled by the control unit 120 could also be used for this purpose. An electrically driven cooling fan of the hydraulic oil cooler 107 of the truck-mounted concrete pump 100 can, for example, be supplied with electrical drive energy from the auxiliary unit 200. In the case of a hydraulic drive of the cooling fan, this can, for example, be supplied with hydraulic energy from the auxiliary unit 200, like the backflow hydraulic motor 307.

In order to ensure the compressed air supply to the truck-mounted concrete pump 100, an air compressor 227 driven by an electric motor 228 is provided in the example shown in FIG. 4, which conveys the compressed air to the truck-mounted concrete pump 100 via a connecting line. Alternatively, the air compressor 227 could also be arranged on the hydraulic pump train 202 and driven by the electric motor 203. Alternatively, a hydraulic motor could drive the compressor.

FIG. 5 shows an alternative electrical circuit diagram for the power supply of the auxiliary unit 200 of the system according to the invention for the electrical drive of a truck-mounted concrete pump 100.

In contrast to the circuit diagram shown in FIG. 3, the low-voltage power supply is not shown here for reasons of clarity. Instead, the cooling circuit 231 required for cooling the components is shown with dashed lines in FIG. 5. The high-voltage power supply (AC and DC) is shown in FIG. 5 with solid lines and control lines with dotted lines.

The main difference in the electrical control in FIG. 5 compared to FIG. 3 is that two power connections 207a and 207b are provided. These can be identical power connections (e.g. 440V/63A three-phase current in each case) or power connections with different power ratings. If the construction site power supply allows the connection of both power connections 207a and 207b, the electric motor 203 can be driven with a correspondingly higher electrical output, so that the truck-mounted concrete pump 100 can also pump the concrete with a higher output. If only one site power connection is available, the auxiliary unit 200 is supplied with a correspondingly lower electrical power.

A power line leads from the power connections 207a and 207b to each of the two converters 224a and 224b in order to convert the AC voltages of the construction site power connections into a high-voltage DC voltage, for example 655 volts DC. Each converter 224a and 224b consists, for example, of one or more commercially available high-voltage chargers connected in parallel. In the exemplary embodiment shown here, both power connections 207a and 207b are identical, so that identical converters 224a and 224b also result. In the event that one of the power connections 207a or 207b is designed, for example, for a lower electrical AC voltage, current or also for a DC voltage connection (e.g. a CCS DC voltage supply, as is known for charging electric vehicles), the converters 224a and 224b will be different or may be completely omitted.

The inverters 224a and 224b supply both the accumulator 206 and the inverter 219, which supplies the electric motor 203 with electrical alternating current, with high-voltage DC voltage. The control unit 220 connected to an input and output unit 227 controls, adapted to the respective operating situation, the current consumption and current output of the inverters 224a, 224b, the high-voltage accumulator 206 and the inverter 219 via the control lines shown in dotted lines. For example, if the electric motor 203 requires little or no electrical power due to an interruption in pumping of the truck-mounted concrete pump 100, the control unit 220 can cause the accumulator 206 to use excess power from the power connections 207a and 207b for charging. If a high electrical drive power is required for the electric motor 203 during pump operation, this power can be provided in parallel by the accumulator 206 and by the inverters 224a and 224b. The control unit 220, for example, can be PLC-based and connected to the individual modules via CAN interfaces.

A ground fault monitor 232 constantly checks the system for ground faults and other residual currents and can trigger an emergency shutdown if necessary.

The auxiliary unit 200 also has an emergency stop circuit, which is not shown. This means that when an emergency stop switch or button connected to the control unit 220 is actuated, all or parts of the functions of the auxiliary unit 200 are switched off. Furthermore, the control unit 220 of the auxiliary unit signals the emergency stop actuation on the auxiliary unit 200 to the control unit 120 of the truck-mounted concrete pump 100, so that an emergency stop is also automatically triggered on the truck-mounted concrete pump. Conversely, pressing an emergency stop button on the truck-mounted concrete pump 100 also triggers an emergency stop on the auxiliary unit 200.

The exemplary shown cooling circuit 231 for the liquid cooling of the components includes a pump 229 driven by a low-voltage electric motor and a cooler 230. The cooling liquid is first conveyed to the accumulator 206, which is the most demanding in terms of cooling. From the accumulator 206, the coolant is channelled in parallel to the inverters 224a and 224b and to the inverter 219, before finally passing through the electric motor 203 to the cooler 230. Depending on the cooling capacity requirement and the temperature sensitivity of the individual components, other routes of the cooling circuit 231 are conceivable.

It should be noted that two exemplary versions of the hydraulic hydraulic system (FIGS. 2 and 4) and the electrical system (FIGS. 3 and 5) have been presented. Any technologically sensible adaptations and combinations of the examples shown here that are familiar to the skilled person and combinations of the design examples shown here could be made to both the hydraulic hydraulic as well as the electric drive, without deviating from the basic idea of the invention.

### REFERENCE SIGN LIST

100 Truck-mounted concrete pump
102 Hydraulic pump drive system I (truck-mounted concrete pump)
102a-d Hydraulic pumps
103 Combustion engine
105 Oil filter truck mounted concrete pump
107 Hydraulic oil cooler truck mounted concrete pump
108 Hydraulic oil tank truck mounted concrete pump
109a-d Hydraulic supply line
109e,f Hydraulic control line
110 Concrete pump system
111 Agitator
112 Concrete switching valve
113 Support
114 Two-cylinder piston pump
115 Concrete placing boom
116 Feed hopper
120 Control unit truck mounted concrete pump
130 Truck chassis
121a-d Hydraulic backflow lines truck mounted concrete pump
122 Remote control truck mounted concrete pump
200 Auxiliary unit
202 Auxiliary hydraulic pump drive system
202a-e Hydraulic pumps
203 Electric motor
205 Power distribution unit
206 High voltage accumulator
207 Power connection
208 Auxiliary hydraulic oil tank
209a-d Hydraulic supply line
209 e,f Hydraulic control line
209g, h Hydraulic backflow line
210 Hydraulic oil cooler
211 Min-/Max Sensor oil level
212 Oil level sensor
213 Temperature sensor
214 Min-/Max Sensor temperature
215 Hydraulic oil filter
216 Oil filter sensor
217 Electric motor oil cooler
218 Current-/power sensor
220 Control unit/auxiliary unit
221 DC converter
222 AC converter
223 AC converter
224 AC/DC converter
225 Accumulator (24V/48V)
226 Power cable
227 Input/Output unit
228 E-motor compressor drive
229 Cooling pump
230 Cooler
231 Cooling circuit
232 Ground fault monitor
301a-e Check valves
304a- d Hydraulic quick coupling supply
304 e, f Hydraulic quick coupling
304 g,h Hydraulic quick coupling backflow
305a Hydraulic backflow pump tank
305b Hydraulic backflow pump oil cooler
305 Hydraulic backflow pump (alternative)
306 Backflow drive motor, electric
307 Backflow drive motor, hydraulic
308 Connection electric backflow motor
309g, h Suction line backflow pump
310 Supply voltage connection
311 Air compressor
312 Control connection
400 Construction site power distributor

1-18. (canceled)

19. An auxiliary unit for electrically driving a truck-mounted concrete pump, wherein the truck-mounted concrete pump has a hydraulically driven concrete pump system for conveying concrete and a hydraulic pump drive system, a hydraulic oil tank, and an internal combustion engine, wherein the internal combustion engine is arranged to drive the hydraulic pump drive system, wherein the hydraulic pump drive system is arranged to drive the concrete pump system, wherein the auxiliary unit has an auxiliary hydraulic pump drive system and an electric motor for driving the auxiliary hydraulic pump drive system, wherein the auxiliary hydraulic pump drive system is configured to be connected to the truck-mounted concrete pump for driving the concrete pump system.

20. The auxiliary unit of claim 19, wherein the auxiliary unit has an auxiliary hydraulic oil tank for holding hydraulic oil, wherein the hydraulic oil tank of the truck-mounted concrete pump is configured to be connected to the auxiliary hydraulic oil tank of the auxiliary unit via at least one hydraulic backflow line.

21. The auxiliary unit of claim 20, wherein the hydraulic oil is conveyable from the hydraulic oil tank of the truck-mounted concrete pump to the auxiliary hydraulic oil tank of the auxiliary unit via the at least one hydraulic backflow line.

22. The auxiliary unit of claim 21, wherein the truck-mounted concrete pump has at least one backflow drive motor and at least one hydraulic oil backflow pump, wherein the at least one hydraulic oil backflow pump is configured to convey the hydraulic oil from the hydraulic tank of the truck-mounted concrete pump to the auxiliary hydraulic oil tank of the auxiliary unit.

23. The auxiliary unit of claim 22, wherein the backflow drive motor is an electric motor.

24. The auxiliary unit of claim 22, wherein the backflow drive motor is a hydraulic motor.

25. The auxiliary unit of claim 20, wherein the auxiliary unit has a hydraulic oil cooler, wherein the hydraulic oil is conveyable from the hydraulic tank of the truck-mounted concrete pump through the at least one hydraulic backflow line through the hydraulic oil cooler of the auxiliary unit into the auxiliary hydraulic oil tank of the auxiliary unit.

26. The auxiliary unit of claim 22, wherein the auxiliary unit comprises a control unit, wherein the control unit is configured to regulate power of the backflow drive motor.

27. The auxiliary unit of claim 19, wherein the auxiliary unit has an electrical supply voltage connection for the electrical supply of a control unit of the truck-mounted concrete pump.

28. A truck-mounted concrete pump system comprising:
a hydraulically driven concrete pumping system for conveying concrete, a hydraulic pump drive system, and an internal combustion engine,
the internal combustion engine configured to drive the hydraulic pump drive system,
the hydraulic pump drive system configured to drive the concrete pumping system,
wherein the concrete pump system of the truck-mounted concrete pump is connected to an auxiliary unit,
the auxiliary unit having an auxiliary hydraulic pump drive system and an electric motor, the auxiliary hydraulic pump drive system configured to drive the concrete pump system of the truck-mounted concrete pump, the electric motor configured to drive the auxiliary hydraulic pump drive system.

29. The truck-mounted concrete pump system of claim 28, wherein the truck-mounted concrete pump comprises a backflow drive motor, a hydraulic backflow pump configured to be driven by the backflow drive motor, and a hydraulic oil tank, wherein the hydraulic backflow pump is configured to supply hydraulic oil from the hydraulic oil tank of the truck-mounted concrete pump and a hydraulic oil tank, wherein the hydraulic backflow pump is configured to convey the hydraulic oil from the hydraulic oil tank of the truck-mounted concrete pump to the auxiliary unit.

30. The truck-mounted concrete pump system of claim 29, wherein the hydraulic backflow pump is configured to convey the hydraulic oil from the hydraulic oil tank of the truck-mounted concrete pump to the auxiliary hydraulic oil tank of the auxiliary unit.

31. The truck-mounted concrete pump system of claim 28, wherein the hydraulic pump drive system of the truck-mounted concrete pump comprises a plurality of hydraulic pumps, wherein the concrete pump system of the truck-mounted concrete pump comprises a plurality of hydraulic consumers, wherein the auxiliary hydraulic pump drive system of the auxiliary unit has a plurality of hydraulic pumps, wherein the hydraulic consumers are connected to the plurality of hydraulic pumps of the auxiliary unit via a plurality of hydraulic supply lines.

32. A system comprising:
a truck-mounted concrete pump having a hydraulically driven concrete pumping system for conveying concrete, a hydraulic pump drive system, and an internal combustion engine, the internal combustion engine configured to drive the hydraulic pump drive system, the hydraulic pump drive system configured to drive the concrete pumping system; and
an auxiliary unit having an auxiliary hydraulic pump drive system for hydraulically driving the concrete pump system and an electric motor for driving the auxiliary hydraulic pump drive system, wherein the auxiliary hydraulic pump drive system of the auxiliary unit is connected to the concrete pump system of the truck-mounted concrete pump via hydraulic supply lines.

33. The system of claim 32, wherein the concrete pump system of the truck-mounted concrete pump has a plurality of hydraulic consumers and in that the hydraulic pump drive system of the truck-mounted concrete pump has a plurality of hydraulic pumps for driving the plurality of hydraulic consumers and in that the auxiliary hydraulic pump drive system of the auxiliary unit has a plurality of hydraulic pumps for driving the plurality of hydraulic consumers and in that the auxiliary hydraulic pump drive system of the auxiliary unit comprises a plurality of hydraulic pumps and wherein the hydraulic consumers of the truck-mounted concrete pump can be connected to the plurality of hydraulic pumps of the auxiliary unit by means of a plurality of hydraulic supply lines.

34. The system of claim 32, wherein the truck-mounted concrete pump has a hydraulic oil tank, wherein the auxiliary unit has an auxiliary hydraulic oil tank, wherein the hydraulic oil tank of the truck-mounted concrete pump and the auxiliary hydraulic oil tank of the auxiliary unit are connected to one another by at least one hydraulic backflow line.

35. The system of claim 34, wherein the truck-mounted concrete pump comprises a hydraulic oil backflow pump connected to the hydraulic oil tank of the truck-mounted concrete pump and a backflow drive motor, wherein the backflow drive motor is configured to drive the hydraulic oil backflow pump, wherein the hydraulic oil backflow pump is configured to convey the hydraulic oil from the hydraulic oil tank of the truck-mounted concrete pump to the auxiliary hydraulic oil tank of the auxiliary unit through the at least one hydraulic backflow line.

36. The system of claim 35, wherein the truck-mounted concrete pump has a second hydraulic oil backflow pump driven by the backflow drive motor, wherein the auxiliary unit has a hydraulic oil cooler and a second hydraulic backflow line connected to the hydraulic oil cooler, wherein the second hydraulic oil backflow pump is configured to feed the hydraulic oil from the hydraulic oil tank of the truck-mounted concrete pump through the hydraulic oil cooler into the hydraulic oil tank of the auxiliary unit.
